(19) United States
(12) Patent Application Publication
(10) Pub. No.: US 2016/0110094 A1
(43) Pub. Date: Apr. 21, 2016

(54) MOBILE TERMINAL AND CONTROL METHOD THEREOF

(71) Applicant: LG ELECTRONICS INC., Seoul (KR)

(72) Inventors: Dongik KIM, Seoul (KR); Hyuntaek KWON, Seoul (KR); Yongbeom MA, Seoul (KR); Namyoung KIM, Seoul (KR); Jaekul LEE, Seoul (KR); Jeonghwan HWANG, Seoul (KR)

(73) Assignee: LG ELECTRONICS INC., Seoul (KR)

(21) Appl. No.: 14/894,455

(22) PCT Filed: Dec. 24, 2013
(86) PCT No.: PCT/KR2013/012121

§ 371 Date: Nov. 27, 2015

(30) Foreign Application Priority Data
Jul. 5, 2013 (KR) 10-2013-0079169

(51) Int. Cl. G06F 3/0488; G06F 3/0481; G06F 3/14

(52) U.S. Cl. CPC G06F 3/04883; G06F 3/14; G06F 3/04817

(57) ABSTRACT

A mobile terminal capable of receiving a touch input and a control method thereof are provided. The mobile terminal includes: a display unit configured to receive a touch input drawn along a portion or the entirety of a shape of an icon corresponding to a pre-set application and output the icon according to the touch input; and a controller configured to execute the application corresponding to the icon drawn along the touch input.

### TECHNICAL FIELD

The present invention relates to a mobile terminal and, more particularly, to a mobile terminal capable of receiving touch inputs and a control method thereof.

### BACKGROUND ART

In general, terminals may be divided into a mobile terminal and stationary terminal according to whether or not terminals are movable. In addition, mobile terminals may be divided into a handheld terminal and a vehicle mount terminal according to whether or not users can directly carry it around.

As such functions become more diversified, the mobile terminal can support more complicated functions such as capturing images or video, reproducing music or video files, playing games, receiving broadcast signals, and the like. By comprehensively and collectively implementing such functions, the mobile terminal may be embodied in the form of a multimedia player or device. Efforts are ongoing to support and increase the functionality of mobile terminals. Such efforts include software and hardware improvements, as well as changes and improvements in the structural components which form the mobile terminal.

On the strength of such improvements, mobile terminals may execute various applications. However, when a particular application is desired to be executed, an icon corresponding to the particular application should be searched among icons corresponding to a plurality of applications output to a home screen, causing inconvenience.

In addition, in a case in which a second application is intended to be executed while a first application is being executed, the first application being executed should be terminated, the home screen should be output again, and an icon corresponding to the second application should be searched.

### DISCLOSURE OF INVENTION

### Technical Problem

As aspect of the present invention provides a mobile terminal capable of enhancing user convenience in executing applications, and a control method thereof.

To achieve these and other advantages and in accordance with the purpose of the present invention, as embodied and broadly described herein, the present invention provides in one aspect a mobile terminal including: a display unit configured to receive a touch input drawn along a portion or the entirety of a shape of an icon corresponding to a pre-set application and output the icon according to the touch input; and a controller configured to execute the application corresponding to the icon drawn along the touch input.

In an embodiment of the present invention, when the touch input drawn along a portion or the entirety of the shape of the icon corresponding to the pre-set application on a pre-set basic icon is applied, the controller may output the icon according to the touch input and execute the application corresponding to the icon.

In an embodiment of the present invention, the controller may output a list of icons corresponding to a plurality of pre-set applications, respectively.

In an embodiment of the present invention, when a touch input drawn along a portion or the entirety of an icon corresponding to a second application is applied while a first application is being executed, the controller may output an icon corresponding to the second application and execute the second application according to the touch input.

In an embodiment of the present invention, when a touch input drawn along a shape of an icon corresponding to a pre-set control command is applied, the controller may output the icon and execute the control command according to the touch input.

### Solution to Problem

To achieve these and other advantages and in accordance with the purpose of the present invention, as embodied and broadly described herein, the present invention provides in another aspect a control method of a mobile terminal, including: (a) receiving a touch input drawn along a portion or the entirety of a shape of an icon corresponding to a pre-set application; and (b) outputting the icon drawn along the touch input and executing the application corresponding to the icon.

In an embodiment of the present invention, the operation (a) may include: receiving a touch input drawn along a portion or the entirety of the shape of the icon corresponding to the pre-set application on a pre-set basic icon, and the operation (b) may include: outputting the icon according to the touch input and executing the application corresponding to the icon.

In an embodiment of the present invention, the operation (a) may include: outputting a list of icons corresponding to a plurality of pre-set applications, respectively.

In an embodiment of the present invention, the operation (a) may include: receiving a touch input drawn along a portion or the entirety of an icon corresponding to a second application while a first application is being executed; and the operation (b) may include: outputting an icon corresponding to the second application and executing the second application according to the touch input.

In an embodiment of the present invention, the operation (a) may include: receiving a touch input drawn along a shape of an icon corresponding to a pre-set control command, and the operation (b) may include: outputting the icon and executing the control command according to the touch input.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### Advantageous Effects of Invention

Since it is difficult to output a plurality of application icons at a time in such a small terminal, the application execution method according to the embodiments of the present invention may be advantageously used.

According to embodiments of the present invention, a desired application may be executed through a simple and intuitive touch input, without having to search an icon corresponding to the application from a home screen.

Also, in a case in which a second application is desired to be executed, while a first application is being executed, inconvenience of the related art method in which the execution of the first application is terminated, a home screen is output again, and an icon corresponding to the second application should be searched can be resolved. Namely, in an embodiment of the present invention, the second application can be executed immediately by applying a touch input, while the first application is being executed. As a result, user convenience can be enhanced.

### BRIEF DESCRIPTION OF DRAWINGS

The present invention will become more fully understood from the detailed description given hereinbelow and the accompanying drawings, which are given by illustration only, and thus are not limitative of the present invention, and wherein:

FIG. 1 is a block diagram of a mobile terminal according to an embodiment of the present invention.

FIGS. 2A and 2B are conceptual views of communication systems in which the mobile terminal according to an embodiment of the present invention is operable.

FIG. 3A is a front perspective view of the mobile terminal related to the present invention.

FIG. 3B is a rear perspective view of the mobile terminal illustrated in FIG. 3A.

FIG. 4 is a flow chart illustrating an embodiment of the mobile terminal according to the present invention.

FIG. 5 is a conceptual view illustrating an embodiment of a user interface for executing a relevant application according to a touch input drawn on a pre-set basic icon.

FIG. 6 is a conceptual view illustrating an embodiment of icons corresponding to a plurality of applications, respectively.

FIGS. 7 through 9 are conceptual views illustrating an embodiment of a user interface for executing a relevant application when a touch input drawn along the icons of FIG. 6 is applied.

FIG. 10 is a conceptual view illustrating an embodiment of icons corresponding to applications drawn on (or added to) a basic icon.

FIG. 11 is a conceptual view illustrating an embodiment of a user interface for outputting a list icons corresponding a plurality of pre-set applications, respectively.

FIG. 12 is a conceptual view illustrating embodiments of a user interface for switching an application being executed.

FIG. 13 is a conceptual view illustrating an embodiment of a user interface for executing a pre-set control command according to a touch input drawn along a shape of an icon corresponding to the control command.

FIG. 14 is a conceptual view illustrating an embodiment of a user interface related to unlocking.

FIG. 15 is a conceptual view illustrating an embodiment of implementing a mobile terminal according to the present invention.

### MODE FOR THE INVENTION

The embodiments of the present invention will now be described with reference to the accompanying drawings, in which like numbers refer to like elements throughout although the embodiments are different, and a description of the like elements a first embodiment will be used for those of the different embodiment. In the following description, usage of suffixes such as ‘module’, ‘part’ or ‘unit’ used for referring to elements is given merely to facilitate explanation of the present invention, without having any significant meaning by itself. In describing the present invention, if a detailed explanation for a related known function or construction is considered to unnecessarily divert the gist of the present invention, such explanation has been omitted but would be understood by those skilled in the art. The accompanying drawings of the present invention aim to facilitate understanding of the present invention and should not be construed as limited to the accompanying drawings.

Mobile terminals described in the present disclosure may include mobile phones, smart phones, notebook computers, tablet computers, digital broadcast receivers, PDAs (Personal Digital Assistants), PMPs (Portable Multimedia Player), navigation devices, slate PCs, tablet PCs, ultra-books, and the like. However, it would be understood by a person skilled in the art that the configuration according to embodiments of the present invention can be also applicable to the fixed types of terminals such as digital TVs, desk top computers, and the like, except for any elements especially configured for a mobile purpose.

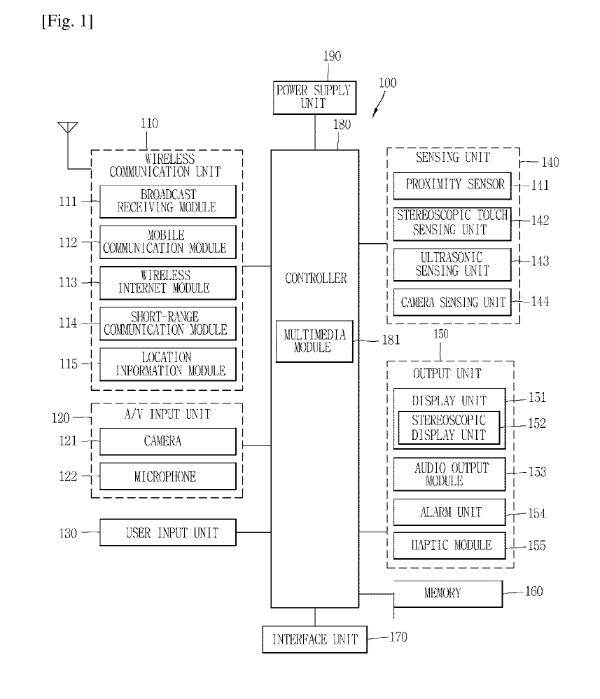

FIG. 1 is a block diagram of a mobile terminal according to an embodiment of the present invention.

The mobile terminal 100 may include a wireless communication unit 110, an A/V (Audio/Video) input unit 120, a user input unit 130, a sensing unit 140, an output unit 150, a memory 160, an interface unit 170, a controller 180, and a power supply unit 190, etc. FIG. 1 shows the mobile terminal as having various components, but it should be understood that implementing all of the illustrated components is not a requirement. Greater or fewer components may alternatively be implemented.

The elements of the mobile terminal will be described in detail as follows.

The wireless communication unit 110 typically includes one or more modules allowing radio communication between the mobile terminal 100 and a wireless communication system or a network in which the mobile terminal is located. For example, the wireless communication unit may include at least one of a broadcast receiving module 111, a mobile communication module 112, a wireless Internet module 113, a short-range communication module 114, and a location information module 115.

The broadcast receiving module 111 receives broadcast signals and/or broadcast associated information from an external broadcast management server (or other network entity) via a broadcast channel.

The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may refer to information associated with a broadcast channel, a broadcast program or a broadcast service provider. The broadcast associated information may also be provided via a mobile communication network and, in this case, the broadcast associated information may be received by the mobile communication module 112.

The broadcast associated information may exist in various forms. For example, it may exist in the form of an electronic program guide (EPG) of digital multimedia broadcasting (DMB), electronic service guide (ESG) of digital video broadcast-handheld (DVB-H), and the like.

The broadcast receiving module 111 may be configured to receive signals broadcast by using various types of broadcast systems. In particular, the broadcast receiving module 111 may receive a digital broadcast by using a digital broadcast system such as multimedia broadcasting-terrestrial (DMB-T), digital multimedia broadcasting-satellite (DMB-S), digital video broadcast-handheld (DVB-H), the data broadcasting system known as media forward link only (MediaFLO®), integrated services digital broadcast-terrestrial (ISDB-T), etc. The broadcast receiving module 111 may be configured to be suitable for every broadcast system that provides a broadcast signal as well as the above-mentioned digital broadcast systems.

Broadcast signals and/or broadcast-associated information received via the broadcast receiving module 111 may be stored in the memory 160.

The mobile communication module 112 transmits and/or receives radio signals to and/or from at least one of a base station, an external terminal and a server. Such radio signals may include a voice call signal, a video call signal or various types of data according to text and/or multimedia message transmission and/or reception.

The wireless Internet module 113 supports wireless Internet access for the mobile terminal. This module may be internally or externally coupled to the terminal. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

The location information module 115 is a module for checking or acquiring a location (or position) of the mobile terminal. A typical example of the location information module is a GPS (Global Positioning System) or a WiFi (Wireless Fidelity) module.

With reference to FIG. 1, the A/V input unit 120 is configured to receive an audio or video signal. The A/V input unit 120 may include a camera 121 and a microphone 122. The camera 121 processes image data of still pictures or video obtained by an image capture device in a video capturing mode or an image capturing mode. The processed image frames may be displayed on a display unit 151.

The image frames processed by the camera 121 may be stored in the memory 160 (or other storage medium) or transmitted via the wireless communication unit 110. Two or more cameras 121 may be provided according to the configuration of the mobile terminal.

The microphone 122 may receive sounds (audible data) via a microphone in a phone call mode, a recording mode, a voice recognition mode, and the like, and can process such sounds into audio data. The processed audio (voice) data may be converted for output into a format transmittable to a mobile communication base station via the mobile communication module 112 in case of the phone call mode. The microphone 122 may implement various types of noise canceling (or suppression) algorithms to cancel (or suppress) noise or interference generated in the course of receiving and transmitting audio signals.

The user input unit 130 may generate input data from commands entered by a user to control various operations of the mobile terminal. The user input unit 130 may include a keypad, a dome switch, a touch pad, a jog wheel, a jog switch, and the like.

The sensing unit 140 detects a current status (or state) of the mobile terminal 100 such as an opened or closed state of the mobile terminal 100, a location of the mobile terminal 100, the presence or absence of user contact with the mobile terminal 100 (i.e., touch inputs), the orientation of the mobile terminal 100, an acceleration or deceleration movement and direction of the mobile terminal 100, etc., and generates commands or signals for controlling the operation of the mobile terminal 100. For example, when the mobile terminal 100 is implemented as a slide type mobile phone, the sensing unit 140 may sense whether the slide phone is opened or closed. In addition, the sensing unit 140 can detect whether or not the power supply unit 190 supplies power or whether or not the interface unit 170 is coupled with an external device.

The output unit 150 is configured to provide outputs in a visual, audible, and/or tactile manner (e.g., audio signal, video signal, alarm signal, vibration signal, etc.). The output unit 150 may include the display unit 151, an audio output module 153, an alarm unit 154, a haptic module 155, and the like.

The display unit 151 may display (output) information processed in the mobile terminal 100. For example, when the mobile terminal 100 is in a phone call mode, the display unit 151 may display a User Interface (UI) or a Graphic User Interface (GUI) associated with a call or other communication (such as text messaging, multimedia file downloading, etc.). When the mobile terminal 100 is in a video call mode or image capturing mode, the display unit 151 may display a captured image and/or received image, a UI or GUI that shows videos or images and functions related thereto, and the like.

The display unit 151 may include at least one of a Liquid Crystal Display (LCD), a Thin Film Transistor-LCD (TFT-LCD), an Organic Light Emitting Diode (OLED) display, a flexible display, a three-dimensional (3D) display, and an e-ink display.

Some of them may be configured to be transparent or light-transmissive to allow viewing of the exterior, which may be called transparent displays. A typical transparent display may be, for example, a TOLED (Transparent Organic Light Emitting Diode) display, or the like. Through such configuration, the user can view an object positioned at the rear side of the terminal body through the region occupied by the display unit 151 of the terminal body.

The mobile terminal 100 may include two or more display units according to its particular desired embodiment. For example, a plurality of display units may be separately or integrally disposed on one surface of the mobile terminal, or may be separately disposed on mutually different surfaces.

Also, the display unit 151 may be configured as a stereoscopic display unit 152 displaying a stereoscopic image.

Here, the stereoscopic image may be a three-dimensional (3D) stereoscopic image, and the 3D stereoscopic image is an image refers to an image making a viewer feel that a gradual depth and reality of an object on a monitor or a screen is the same as a reality space. A 3D stereoscopic image is implemented by using binocular disparity. Binocular disparity refers to disparity made by the positions of two eyes. When two eyes view different 2D images, the images are transferred to the brain through the retina and combined in the brain to provide the perception of depth and reality sense.

The stereoscopic display unit 152 may employ a stereoscopic display scheme such as stereoscopic scheme (a glass scheme), an auto-stereoscopic scheme (glassless scheme), a projection scheme (holographic scheme), or the like. Stereoscopic schemes commonly used for home television receivers, or the like, include Wheatstone stereoscopic scheme, or the like.

The auto-stereoscopic scheme includes, for example, a parallax barrier scheme, a lenticular scheme, an integral imaging scheme, or the like. The projection scheme includes a reflective holographic scheme, a transmissive holographic scheme, or the like.

In general, a 3D stereoscopic image is comprised of a left image (a left eye image) and a right image (a right eye image). According to how left and right images are combined into a 3D stereoscopic image, the 3D stereoscopic imaging method is divided into a top-down method in which left and right images are disposed up and down in a frame, an L-to-R (left-to-right, side by side) method in which left and right images are disposed left and right in a frame, a checker board method in which fragments of left and right images are disposed in a tile form, an interlaced method in which left and right images are alternately disposed by columns and rows, and a time sequential (or frame by frame) method in which left and right images are alternately displayed by time.

Also, as for a 3D thumbnail image, a left image thumbnail and a right image thumbnail are generated from a left image and a right image of the original image frame, respectively, and then combined to generate a single 3D thumbnail image. In general, thumbnail refers to a reduced image or a reduced still image. The thusly generated left image thumbnail and the right image thumbnail are displayed with a horizontal distance difference therebetween by a depth corresponding to the disparity between the left image and the right image on the screen, providing a stereoscopic space sense.

A left image and a right image required for implementing a 3D stereoscopic image is displayed on the stereoscopic display unit 152 by a stereoscopic processing unit 152a. The stereoscopic processing unit may receive the 3D image and extract the left image and the right image, or may receive the 2D image and change it into a left image and a right image.

Meanwhile, when the display unit 151 and a sensor (referred to as a ‘touch sensor’, hereinafter) for detecting a touch operation are overlaid in a layered manner to form a touch screen, the display unit 151 may function as both an input device and an output device. The touch sensor may have a form of a touch film, a touch sheet, a touch pad, and the like.

The touch sensor may be configured to convert pressure applied to a particular portion of the display unit 151 or a change in the capacitance or the like generated at a particular portion of the display unit 151 into an electrical input signal. The touch sensor may be configured to detect the pressure when a touch is applied, as well as the touched position and area.

When there is a touch input with respect to the touch sensor, a corresponding signal (signals) are transmitted to a touch controller. The touch controller processes the signals and transmits corresponding data to the controller 180. Accordingly, the controller 180 may recognize which portion of the display unit 151 has been touched.

With reference to FIG. 1, a proximity sensor 141 may be disposed within or near the touch screen. The proximity sensor 141 is a sensor for detecting the presence or absence of an object relative to a certain detection surface or an object that exists nearby by using the force of electromagnetism or infrared rays without a physical contact. Thus, the proximity sensor 141 has a considerably longer life span compared with a contact type sensor, and it can be utilized for various purposes.

Examples of the proximity sensor 141 may include a transmission type photoelectric sensor, a direct reflection type photoelectric sensor, a mirror-reflection type photoelectric sensor, an RF oscillation type proximity sensor, a capacitance type proximity sensor, a magnetic proximity sensor, an infrared proximity sensor, and the like. In case where the touch screen is the capacitance type, proximity of the pointer is detected by a change in electric field according to the proximity of the pointer. In this case, the touch screen (touch sensor) may be classified as a proximity sensor.

In the following description, for the sake of brevity, recognition of the pointer positioned to be close to the touch screen will be called a ‘proximity touch’, while recognition of actual contacting of the pointer on the touch screen will be called a ‘contact touch’. In this case, when the pointer is in the state of the proximity touch, it means that the pointer is positioned to correspond vertically to the touch screen.

By employing the proximity sensor 141, a proximity touch and a proximity touch pattern (e.g., a proximity touch distance, a proximity touch speed, a proximity touch time, a proximity touch position, a proximity touch movement state, or the like) can be detected, and information corresponding to the detected proximity touch operation and the proximity touch pattern can be outputted to the touch screen.

When a touch sensor is overlaid on the stereoscopic display unit 152 in a layered manner, or when the stereoscopic display unit and a 3D sensor sensing a touch operation are combined, the stereoscopic display unit 152 may also be used as a 3D input device.

As examples of the 3D sensor, the sensing unit 140 may include a proximity sensor 141, a stereoscopic touch sensing unit 142, an ultrasonic sensing unit 143, and a camera sensing unit 144.

The proximity sensor 141 detects the distance between a sensing object (e.g., the user's finger or a stylus) applying a touch by using the force of electromagnetism or infrared rays without a mechanical contact and a detect surface. By using the distance, the terminal recognizes which portion of a stereoscopic image has been touched. In particular, when the touch screen is an electrostatic touch screen, the degree of proximity of the sensing object is detected based on a change of an electric field according to proximity of the sensing object, and a touch to the 3D image is recognized by using the degree of proximity.

The stereoscopic touch sensing unit 142 is configured to detect the strength or duration of a touch applied to the touch screen. For example, the stereoscopic touch sensing unit 142 senses pressure applying a touch, and the applied pressure is strong, the stereoscopic touch sensing unit 142 recognizes the touch as a touch with respect to an object positioned to be farther from the touch screen toward the interior of the terminal.

The ultrasonic sensing unit 143 is configured to recognize position information of the sensing object by using ultrasonic waves.

The ultrasonic sensing unit 143 may include, for example, an optical sensor and a plurality of ultrasonic sensors. The optical sensor is configured to sense light, and the ultrasonic sensors may be configured to sense ultrasonic waves. Since light is very faster than ultrasonic waves, light reaches the optical sensor very earlier than ultrasonic waves reach the ultrasonic sensors. Thus, based on light as a reference signal, a position of a wave generation source may be calculated by using a time difference between a time at which light reaches the optical sensor and a time at which ultrasonic waves reach the ultrasonic sensors.

The camera sensing unit 144 includes at least one of a camera, a photo sensor, and a laser sensor.

For example, the camera and the laser sensor may be combined to detect a touch of the sensing object with respect to a 3D stereoscopic image. When distance information detected by a laser sensor is added to a 2D image captured by the camera, 3D information can be obtained.

In another example, a photo sensor may be laminated on the display device. The photo sensor is configured to scan a movement of the sensing object in proximity to the touch screen. In detail, the photo sensor includes photo diodes and transistors at rows and columns to scan content mounted on the photo sensor by using an electrical signal changing according to the quantity of applied light. Namely, the photo sensor calculates the coordinates of the sensing object according to variation of light to thus obtain position information of the sensing object.

The audio output module 153 may convert and output as sound audio data received from the wireless communication unit 110 or stored in the memory 160 in a call signal reception mode, a call mode, a record mode, a voice recognition mode, a broadcast reception mode, and the like. Also, the audio output module 153 may provide audible outputs related to a particular function performed by the mobile terminal 100 (e.g., a call signal reception sound, a message reception sound, etc.). The audio output module 153 may include a speaker, a buzzer, or other sound generating device.

The alarm unit 154 outputs a signal for informing about an occurrence of an event of the mobile terminal 100. Events generated in the mobile terminal may include call signal reception, message reception, key signal inputs, a touch input etc. In addition to video or audio signals, the alarm unit 154 may output signals in a different manner, for example, to inform about an occurrence of an event. The video or audio signals may be also outputted via the audio output module 153, so the display unit 151 and the audio output module 153 may be classified as parts of the alarm unit 154.

A haptic module 155 generates various tactile effects the user may feel. A typical example of the tactile effects generated by the haptic module 155 is vibration. The strength and pattern of the haptic module 155 can be controlled. For example, different vibrations may be combined to be outputted or sequentially outputted.

Besides vibration, the haptic module 155 may generate various other tactile effects such as an effect by stimulation such as a pin arrangement vertically moving with respect to a contact skin, a spray force or suction force of air through a jet orifice or a suction opening, a contact on the skin, a contact of an electrode, electrostatic force, etc., an effect by reproducing the sense of cold and warmth using an element that can absorb or generate heat.

The haptic module 155 may be implemented to allow the user to feel a tactile effect through a muscle sensation such as fingers or arm of the user, as well as transferring the tactile effect through a direct contact. Two or more haptic modules 155 may be provided according to the configuration of the mobile terminal 100.

The memory 160 may store software programs used for the processing and controlling operations performed by the controller 180, or may temporarily store data (e.g., a phonebook, messages, still images, video, etc.) that are inputted or outputted. In addition, the memory 160 may store data regarding various patterns of vibrations and audio signals outputted when a touch is inputted to the touch screen.

The memory 160 may include at least one type of storage medium including a Flash memory, a hard disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, and an optical disk. Also, the mobile terminal 100 may be operated in relation to a web storage device that performs the storage function of the memory 160 over the Internet.

The interface unit 170 serves as an interface with every external device connected with the mobile terminal 100. For example, the external devices may transmit data to an external device, receives and transmits power to each element of the mobile terminal 100, or transmits internal data of the mobile terminal 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating the authority of using the mobile terminal 100 and may include a user identity module (UIM), a subscriber identity module (SIM) a universal subscriber identity module (USIM), and the like. In addition, the device having the identification module (referred to as ‘identifying device’, hereinafter) may take the form of a smart card. Accordingly, the identifying device may be connected with the terminal 100 via a port.

When the mobile terminal 100 is connected with an external cradle, the interface unit 170 may serve as a passage to allow power from the cradle to be supplied therethrough to the mobile terminal 100 or may serve as a passage to allow various command signals inputted by the user from the cradle to be transferred to the mobile terminal therethrough. Various command signals or power inputted from the cradle may operate as signals for recognizing that the mobile terminal is properly mounted on the cradle.

The controller 180 typically controls the general operations of the mobile terminal. For example, the controller 180 performs controlling and processing associated with voice calls, data communications, video calls, and the like. The controller 180 may include a multimedia module 181 for reproducing multimedia data. The multimedia module 181 may be configured within the controller 180 or may be configured to be separated from the controller 180.

The controller 180 may perform a pattern recognition processing to recognize a handwriting input or a picture drawing input performed on the touch screen as characters or images, respectively.

Also, when a state of the mobile terminal satisfies pre-set conditions, the controller 180 may execute a locked state for limiting an input of a control command of the user. Also, in the locked state, the controller 180 may control a locked screen displayed in the locked state on the basis of a touch input sensed through the display unit 151.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic units designed to perform the functions described herein. In some cases, such embodiments may be implemented by the controller 180 itself.

For software implementation, the embodiments such as procedures or functions described herein may be implemented by separate software modules. Each software module may perform one or more functions or operations described herein.

Software codes can be implemented by a software application written in any suitable programming language. The software codes may be stored in the memory 160 and executed by the controller 180.

Hereinafter, a communication system implementable through the mobile terminal 100 according to an embodiment of the present invention will be described.

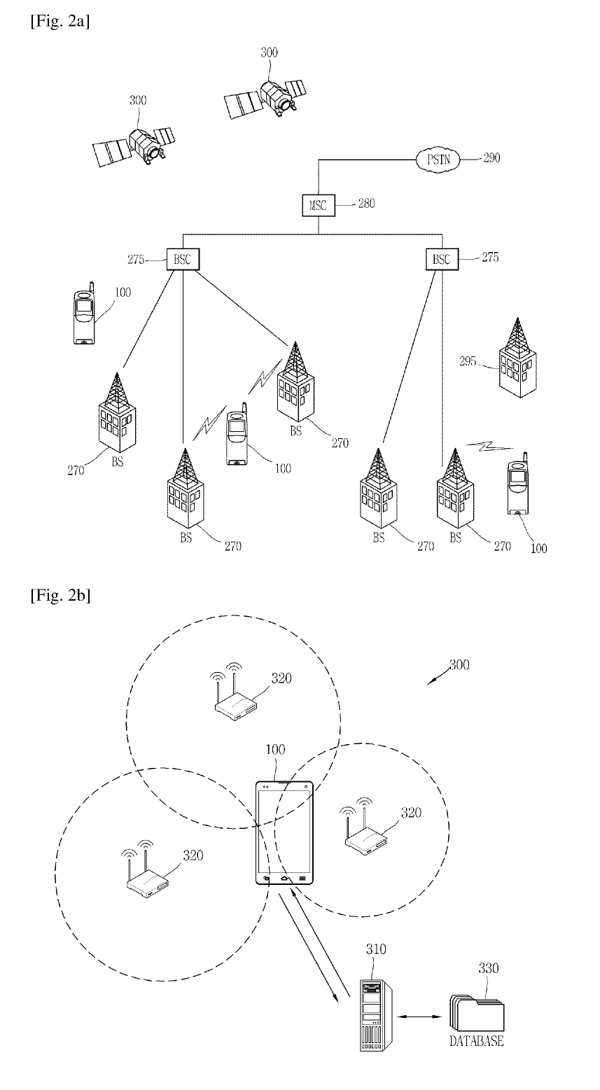

FIGS. 2A and 2B are conceptual views of communication systems in which the mobile terminal 100 according to an embodiment of the present invention is operable.

First, referring to FIG. 2A, a communication system may use different air interfaces and/or physical layers. For example, air interfaces utilized by the communication systems include example, frequency division multiple access (FDMA), time division multiple access (TDMA), code division multiple access (CDMA), and universal mobile telecommunications system (UMTS) (in particular, long term evolution (LTE)), global system for mobile communications (GSM), and the like. As a non-limiting example, the description hereafter relates to a CDMA communication system, but such teachings apply equally to other types of systems.

Hereinafter, for the description purpose, CDMA will be described, but, obviously, the present invention is applicable to any communication system including a CDMA wireless communication system.

Referring to FIG. 2, a CDMA wireless communication system may include a plurality of mobile terminals 100, a plurality of base stations (BSs) 270, base station controllers (BSCs) 275, and a mobile switching center (MSC) 280. The MSC 280 is configured to interface with a public switch telephone network (PSTN) 290. The MSC 280 is also configured to interface with the BSCs 275, which may be coupled to the base stations 270 via backhaul lines. The backhaul lines may be configured in accordance with any of several known interfaces including, for example, E1/T1, ATM, IP, PPP, Frame Relay, HDSL, ADSL, or xDSL. It is to be understood that the system as shown in FIG. 2 may include a plurality of BSCs 275.

Each BS 270 may serve one or more sectors (or regions), each sector covered by an omni-directional antenna or an antenna pointed in a particular direction radially away from the BS 270. Alternatively, each sector may be covered by two or more antennas for diversity reception. Each BS 270 may be configured to support a plurality of frequency assignments, and each frequency assignment has a particular spectrum (e.g., 1.25 MHz, 5 MHz, etc).

The intersection of a sector and frequency assignment may be referred to as a CDMA channel. The BS 270 may also be referred to as base station transceiver subsystems (BTSs) or other equivalent terms. In such case, the term “base station” may be used to collectively refer to a single BSC 275 and at least one BS 270. The base station may also be referred to as a “cell site”. Alternatively, individual sectors of a particular BS 270 may be referred to as a plurality of cell sites.

As shown in FIG. 2A, a broadcasting transmitter (BT) 295 transmits a broadcast signal to the mobile terminals 100 operating within the system. The broadcast receiving module 111 as shown in FIG. 1 is provided at the terminal 100 to receive broadcast signals transmitted by the BT 295.

Also, in FIG. 2A, several global positioning systems (GPS) satellites 300 are shown. The satellites 300 help locate at least one of a plurality of terminals 100. In FIG. 2, several satellites 300 are depicted, but it is understood that useful positioning information may be obtained with any number of satellites. The GPS module 115 as shown in FIG. 1 is typically configured to cooperate with the satellites 300 to obtain desired positioning information. Instead of or in addition to GPS tracking techniques, other technologies that may track the location of the mobile terminals may be used. In addition, at least one of the GPS satellites 300 may selectively or additionally handle satellite DMB transmissions.

As one typical operation of the wireless communication system, the BSs 270 receive reverse-link signals from various mobile terminals 100. The mobile terminals 100 typically engaging in calls, messaging, and other types of communications. Each reverse-link signal received by a particular base station 270 is processed within the particular BS 270. The resulting data is forwarded to an associated BSC 275. The BSC provides call resource allocation and mobility management functionality including the coordination of soft handoff procedures between BSs 270. The BSCs 275 also route the received data to the MSC 280, which provides additional routing services for interfacing with the PSTN 290. Similarly, the PSTN 290 interfaces with the MSC 280, the MSC interfaces with the BSCs 275, and the BSCs 275 in turn control the BSs 270 to transmit forward-link signals to the mobile terminals 100.

Next, a method of acquiring the location information of a mobile terminal using a WiFi (Wireless Fidelity) positioning system (WPS) will be described with reference to FIG. 2B.

The WiFi positioning system (WPS) 300 refers to a location determination technology based on a wireless local area network (WLAN) using WiFi as a technology for tracking the location of the mobile terminal 100 using a WiFi module provided in the mobile terminal 100 and a wireless access point 320 for transmitting and receiving to and from the WiFi module.

The WiFi positioning system 300 may include a WiFi location determination server 310, a mobile terminal 100, a wireless access point (AP) 320 connected to the mobile terminal 100, and a database 330 stored with any wireless AP information.

The WiFi location determination server 310 extracts the information of the wireless AP 320 connected to the mobile terminal 100 based on a location information request message (or signal) of the mobile terminal 100. The information of the wireless AP 320 may be transmitted to the WiFi location determination server 310 through the mobile terminal 100 or transmitted to the WiFi location determination server 310 from the wireless AP 320.

The information of the wireless AP extracted based on the location information request message of the mobile terminal 100 may be at least one of MAC address, SSID, RSSI, channel information, privacy, network type, signal strength and noise strength.

The WiFi location determination server 310 receives the information of the wireless AP 320 connected to the mobile terminal 100 as described above, and compares the received wireless AP 320 information with information contained in the pre-established database 330 to extract (or analyze) the location information of the mobile terminal 100.

On the other hand, referring to FIG. 2B, as an example, the wireless AP connected to the mobile terminal 100 is illustrated as a first, a second, and a third wireless AP 320. However, the number of wireless APs connected to the mobile terminal 100 may be changed in various ways according to a wireless communication environment in which the mobile terminal 100 is located. When the mobile terminal 100 is connected to at least one of wireless APs, the WiFi positioning system 300 can track the location of the mobile terminal 100.

Next, considering the database 330 stored with any wireless AP information in more detail, various information of any wireless APs disposed at different locations may be stored in the database 330.

The information of any wireless APs stored in the database 330 may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like.

In this manner, any wireless AP information and location information corresponding to the any wireless AP are stored together in the database 330, and thus the WiFi location determination server 310 may retrieve wireless AP information corresponding to the information of the wireless AP 320 connected to the mobile terminal 100 from the database 330 to extract the location information matched to the searched wireless AP, thereby extracting the location information of the mobile terminal 100.

Furthermore, the extracted location information of the mobile terminal 100 may be transmitted to the mobile terminal 100 through the WiFi location determination server 310, thereby acquiring the location information of the mobile terminal 100.

Hereinafter, a mobile terminal according to an embodiment of the present disclosure as illustrated in FIG. 1 or a mobile terminal disposed with the constituent elements of the mobile terminal or the structure of a mobile terminal will be described.

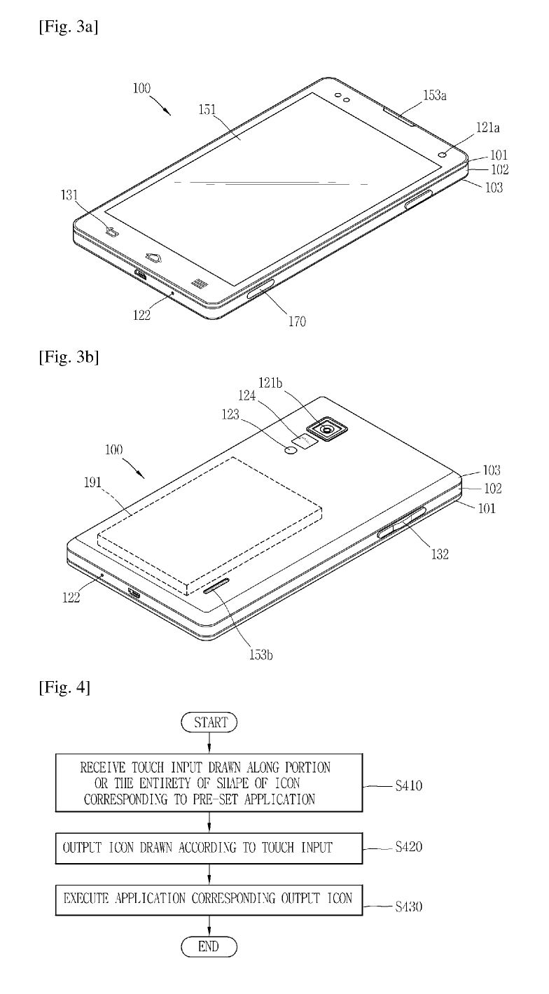

FIG. 3A is a front perspective view illustrating an example of the mobile terminal 100 associated with the present disclosure.

The mobile terminal 100 disclosed herein is provided with a bar-type terminal body. However, the present invention may not be limited to this, but also may be applicable to various structures such as watch type, clip type, glasses type or folder type, flip type, swing type, swivel type, or the like, in which two and more bodies are combined with each other in a relatively movable manner.

The terminal body includes a case (casing, housing, cover, etc.) forming the appearance of the terminal. In this embodiment, the case may be divided into a front case 101 and a rear case 102. Various electronic components are incorporated into a space formed between the front case 101 and the rear case 102. At least one middle case may be additionally disposed between the front case 101 and the rear case 102, and a battery cover 103 for covering the battery 191 may be detachably configured at the rear case 102.

The cases may be formed by injection-molding a synthetic resin or may be also formed of a metal, for example, stainless steel (STS), titanium (Ti), or the like.

A display unit 151, a first audio output module 153a, a first camera 121a, a first manipulating unit 131 and the like may be disposed on a front surface of the terminal body, and a microphone 122, an interface unit 170, a second manipulating unit 132 and the like may be provided on a lateral surface thereof.

The display unit 151 may be configured to display (output) information being processed in the mobile terminal 100. The display unit 151 may include at least one of a liquid crystal display (LCD), a thin film transistor-liquid crystal display (TFT-LCD), an organic light emitting diode (OLED) display, a flexible display, a 3-dimensional (3D) display, and an e-ink display.

The display unit 151 may include a touch sensing means to receive a control command by a touch method. When a touch is made to any one place on the display unit 151, the touch sensing means may be configured to sense this touch and enter the content corresponding to the touched place. The content entered by a touch method may be a text or numerical value, or a menu item capable of indication or designation in various modes.

The touch sensing means may be formed with transparency to allow visual information displayed on the display unit 151 to be seen, and may include a structure for enhancing the visibility of a touch screen at bright places. Referring to FIG. 3A, the display unit 151 occupies a most portion of the front surface of the front case 101.

The first audio output module 153a and the first camera 121a are disposed in a region adjacent to one of both ends of the display unit 151, and the first manipulation input unit 131 and the microphone 122 are disposed in a region adjacent to the other end thereof. The second manipulation unit 132 (refer to FIG. 3B), the interface 170, and the like, may be disposed on a lateral surface of the terminal body.

The first audio output module 153a may be implemented in the form of a receiver for transferring voice sounds to the user's ear or a loud speaker for outputting various alarm sounds or multimedia reproduction sounds.

It may be configured such that the sounds generated from the first audio output module 153a are released along an assembly gap between the structural bodies. In this case, a hole independently formed to output audio sounds may not be seen or hidden in terms of appearance, thereby further simplifying the appearance of the mobile terminal 100. However, the present invention may not be limited to this, but a hole for releasing the sounds may be formed on the window.

The first camera 121a processes video frames such as still or moving images obtained by the image sensor in a video call mode or capture mode. The processed video frames may be displayed on the display unit 151.

The user input unit 130 is manipulated to receive a command for controlling the operation of the mobile terminal 100. The user input unit 130 may include a first and a second manipulation unit 131, 132. The first and the second manipulation unit 131, 132 may be commonly referred to as a manipulating portion, and any method may be employed if it is a tactile manner allowing the user to perform manipulation with a tactile feeling such as touch, push, scroll or the like.

In the present drawing, it is illustrated on the basis that the first manipulation unit 131 is a touch key, but the present disclosure may not be necessarily limited to this. For example, the first manipulation unit 131 may be configured with a mechanical key, or a combination of a touch key and a mechanical key.

The content received by the first and/or second manipulation units 131, 132 may be set in various ways. For example, the first manipulation unit 131 may be used to receive a command such as menu, home key, cancel, search, or the like, and the second manipulation unit 132 may receive a command, such as controlling a volume level being outputted from the first audio output module 153a, or switching into a touch recognition mode of the display unit 151.

The microphone 122 may be formed to receive the user's voice, other sounds, or the like. The microphone 122 may be provided at a plurality of places, and configured to receive stereo sounds.

The interface unit 170 serves as a path allowing the mobile terminal 100 to exchange data with external devices. For example, the interface unit 170 may be at least one of a connection terminal for connecting to an earphone in a wired or wireless manner, a port for near field communication (for example, an Infrared Data Association (IrDA) port, a Bluetooth port, a wireless LAN port, and the like), and a power supply terminal for supplying power to the mobile terminal 100. The interface unit 170 may be implemented in the form of a socket for accommodating an external card such as Subscriber Identification Module (SIM) or User Identity Module (UIM), and a memory card for information storage.

FIG. 3B is a rear perspective view illustrating mobile terminal 100 illustrated in FIG. 3A.

Referring to FIG. 3B, a second camera 121b may be additionally mounted at a rear surface of the terminal body, namely, the rear case 102. The second camera 121b has an image capturing direction, which is substantially opposite to the direction of the first camera unit 121a (refer to FIG. 3A), and may have a different number of pixels from that of the first camera unit 121a.

For example, it is preferable that the first camera 121a has a relatively small number of pixels enough not to cause difficulty when the user captures his or her own face and sends it to the other party during a video call or the like, and the second camera 121b has a relatively large number of pixels since the user often captures a general object that is not sent immediately. The first and the second camera 121a, 121b may be provided in the terminal body in a rotatable and pop-up manner.

A flash 123 and a mirror 124 may be additionally disposed adjacent to the second camera 121b. The flash 123 illuminates light toward an object when capturing the object with the second camera 121b. The mirror 124 allows the user to look at his or her own face, or the like, in a reflected way when capturing himself or herself (in a self-portrait mode) by using the second camera 121b.

A second audio output module 153b may be additionally disposed at a rear surface of the terminal body. The second audio output module 153b together with the first audio output module 153a (refer to FIG. 3A) can implement a stereo function, and may be also used to implement a speaker phone mode during a phone call.

An antenna (not shown) for receiving broadcast signals may be additionally disposed at a lateral surface of the terminal body in addition to an antenna for making a phone call or the like. The antenna constituting part of the broadcast receiving module 111 (refer to FIG. 1) may be provided in the terminal body in a retractable manner.

A power supply unit 190 (refer to FIG. 1) for supplying power to the mobile terminal 100 may be mounted on the terminal body. The power supply unit 190 may be incorporated into the terminal body, or may include a battery 191 configured in a detachable manner on the outside of the terminal body. According to the drawing, it is illustrated that the battery cover 103 is combined with the rear case 102 to cover the battery 191, thereby restricting the battery 191 from being released and protecting the battery 191 from external shocks and foreign substances.

Meanwhile, mobile terminals may execute various applications. However, when a particular application is desired to be executed, an icon corresponding to the particular application should be searched among icons corresponding to a plurality of applications output to a home screen,

In addition, in a case in which a second application is intended to be executed while a first application is being executed, the first application being executed should be terminated, the home screen should be output again, and an icon corresponding to the second application should be searched.

Thus, hereinafter, the mobile terminal 100 capable of enhancing user convenience in executing an application and a control method thereof will be described with reference to the accompanying drawings.

FIG. 4 is a flow chart illustrating an embodiment of the mobile terminal 100 (please see FIG. 1) according to the present invention. The mobile terminal includes the display unit 151 and the controller 180.

Referring to FIG. 4, first, a touch input drawn along a portion or the entirety of an icon corresponding to a pre-set application is received (S410).

Next, the icon drawn according to the touch input is output (S420).

Thereafter, an application corresponding to the icon output in step S420 is executed (S430).

Meanwhile, when a touch input drawn along a portion or the entirety of an icon corresponding to a pre-set application on a pre-set basic icon is applied, the icon is output according to the touch input, and an application corresponding to the icon may be executed.

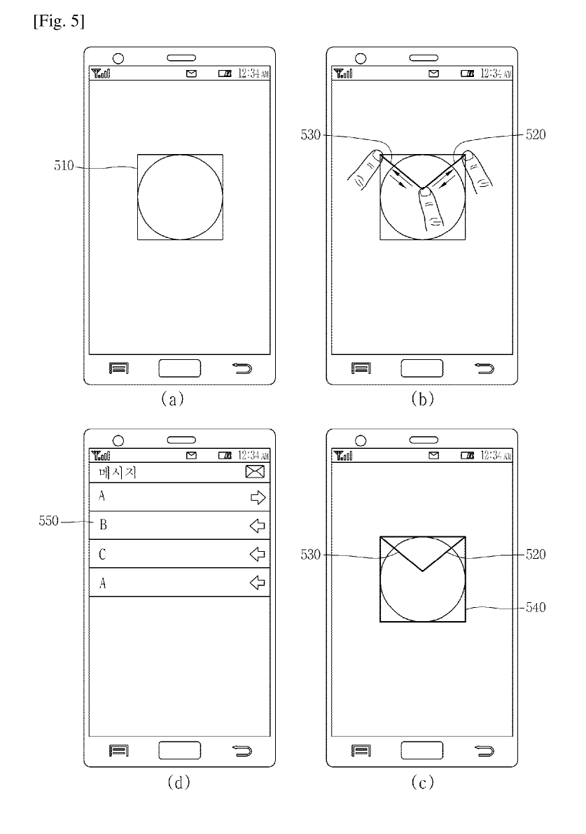

FIG. 5 is a conceptual view illustrating an embodiment of a user interface for executing a relevant application according to a touch input drawn on a pre-set basic icon.

Referring to (a) of FIG. 5, the mobile terminal may enter a mode in which a basic icon 510 is output, in a home screen or while an application is being executed. For example, in a case in which a home button is long-pushed or a button 132 disposed in the side of the mobile terminal 100 is short-touched, the mobile terminal may enter the mode in which the basic icon 510 is output.

The basic icon 510 may be set to have various shapes. For example, the basic icon 510 may be set to have a shape such as a rectangular shape, a square shape, a circular shape, and the like. In an embodiment, the basic icon 510 may be set as a combination of a square and a circle as illustrated in (a) of FIG. 5.

Referring to (b) of FIG. 5, the user may apply a touch input drawn along a portion or the entirety of a shape of an icon corresponding to an application desired to be executed on the basic icon 510.

In an embodiment, when the user draws a portion of a message icon corresponding to a message (text) application on the basic icon 510, the message icon along the user's finger touch may be output. Namely, lines 520 and 530 are drawn on the basic icon 510 according to the user's finger touch.

Also, order in which the icon corresponding to the application is drawn may be arbitrarily set. For example, the line may be drawn continuously from the right 520 to the left 530 or may be drawn continuously from the left 530 to the right 520.

Referring to (c) of FIG. 5, when the user draws along portions 520 or 530 or the entirety 540 of the shape of a message icon on the basic icon 510, the message icon 540 may be output.

In detail, in the case in which the user draws along a portion 520 or 530 of the shape of the message icon, when it is determined that the user has input the message icon 540, the message icon 540 may be automatically drawn and output. Alternatively, when the user draws the entirety 540 of the shape of the message icon, the message icon 540 may be output.

In this case, the message icon 540 and the basic icon 510 in (a) of FIG. 5 may be output together. For example, the message icon 540 may be output as a line thicker than the basic icon 510 or may be out in a different color.

Referring to (d) of FIG. 5, the screen may be changed and a message 550 may be executed.

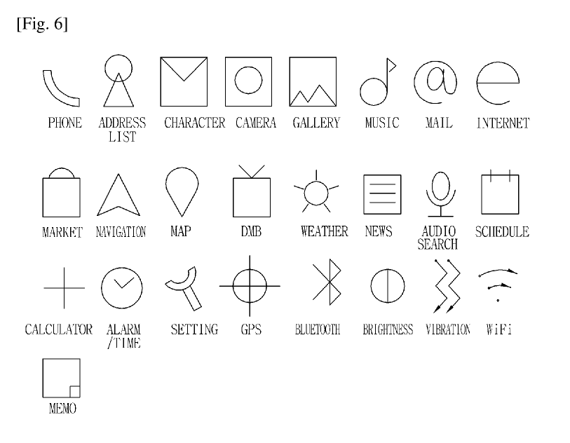

FIG. 6 is a conceptual view illustrating an embodiment of icons corresponding to a plurality of applications, respectively.

Referring to FIG. 6, icons corresponding to phone, an address list, text, camera, gallery, music, mail, messenger, Internet, market, navigation, map, DMB, weather, news, voice search, schedule, calculator, alarm/time, setting, GPS, Bluetooth, brightness, vibration, wifi, memo application, respectively, may be provided.

This corresponds to an embodiment of the present invention, and an icon that may represent a particular application by intuition may be set as an icon corresponding to the particular application.

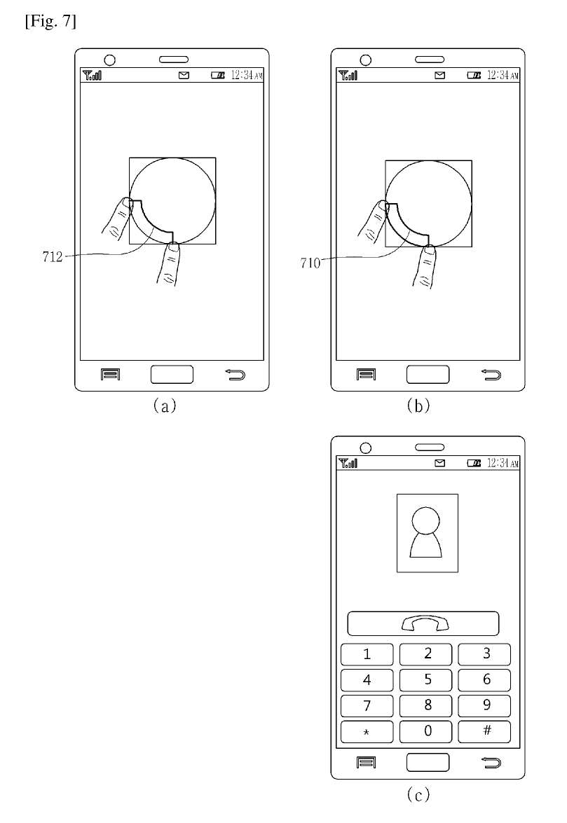

FIGS. 7 through 9 are conceptual views illustrating an embodiment of a user interface for executing a relevant application when a touch input drawn along the icons of FIG. 6 is applied.

Referring to FIG. 7, a line 712 is drawn on the basic icon according a user's finger touch along a shape of an icon 710 corresponding to a phone application. As a result, the icon 710 of the phone application is output and an executed screen of the phone application is displayed.

In this case, although the user draws the line 712 along a portion of the icon 710 of the phone application, when it is determined that the line 712 has been drawn along the icon 710 of the phone application, the icon 710 of the phone application is output and the phone application is subsequently executed.

In detail, although the line 712 is drawn only up to an inner portion of the icon 710 of the phone application, it can be discriminated from the other icons of FIG. 6. Thus, after the completed icon 710 of the phone application is output, the phone application may be executed.

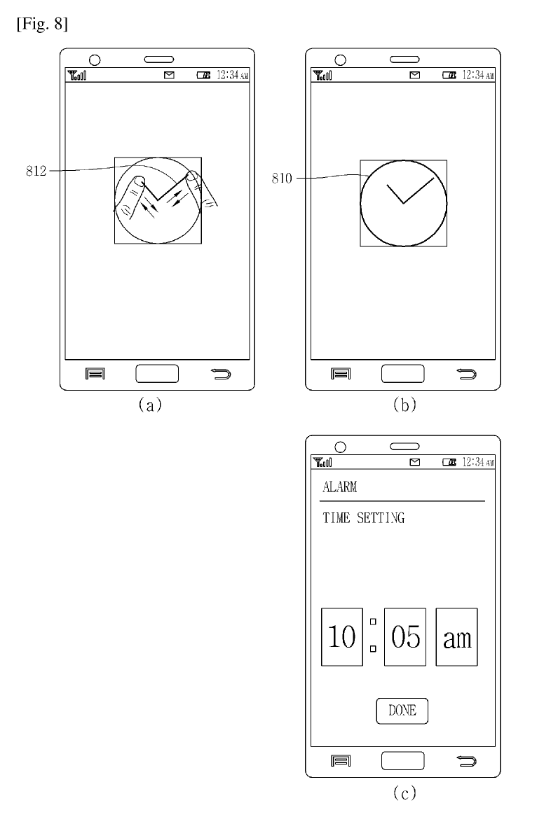

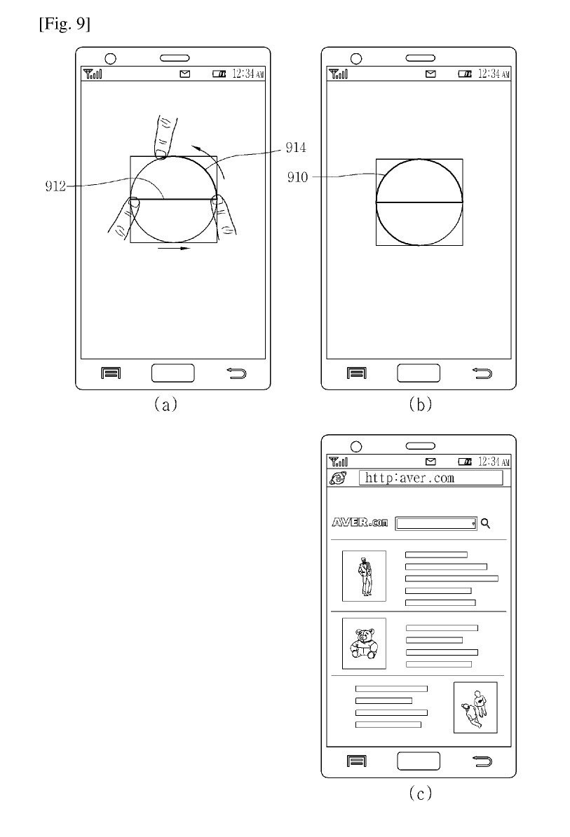

Referring to FIG. 8, a line 812 is drawn on the basic icon according to the user's finger touch along a shape of an icon 810 corresponding to an alarm application. As a result, the icon 810 of the alarm application is output and an executed screen of the alarm application is displayed.

In an embodiment, when an hour hand and a minute hand 812 are drawn along the basic icon, a remaining circle corresponding to the icon 810 of the alarm application is output. Namely, the icon 810 of the alarm application is output and an executed screen of the alarm application is subsequently output.

In another embodiment, only when the user draws the shape of the icon 810 of the alarm application entirely, the icon 810 of the alarm application may be output and the alarm application may be subsequently executed.

Referring to FIG. 9, lines 912 and 914 are drawn on the basic icon according to the user's finger touch along a shape of an icon 910 corresponding to an Internet application of FIG. 6. As a result, the icon 910 of the Internet application is output and an executed screen of the Internet application is displayed.

Also, order that the user draws the shape of the icon 910 corresponding to the application may be random. For example, the user may draw the inner linear line 912 of the icon of the Internet application and subsequently draw a portion 914 of the circle in a counterclockwise direction. Alternatively, the user may draw the icon 910 of the Internet application in reverse order.

In another embodiment, it is not necessary to continuously draw a shape of an icon corresponding to an application. For example, the user may draw the inner linear line 912 of the icon 910 of the Internet application, pull out the user's finger touch in a while, and thereafter, draw the remaining shape 914.

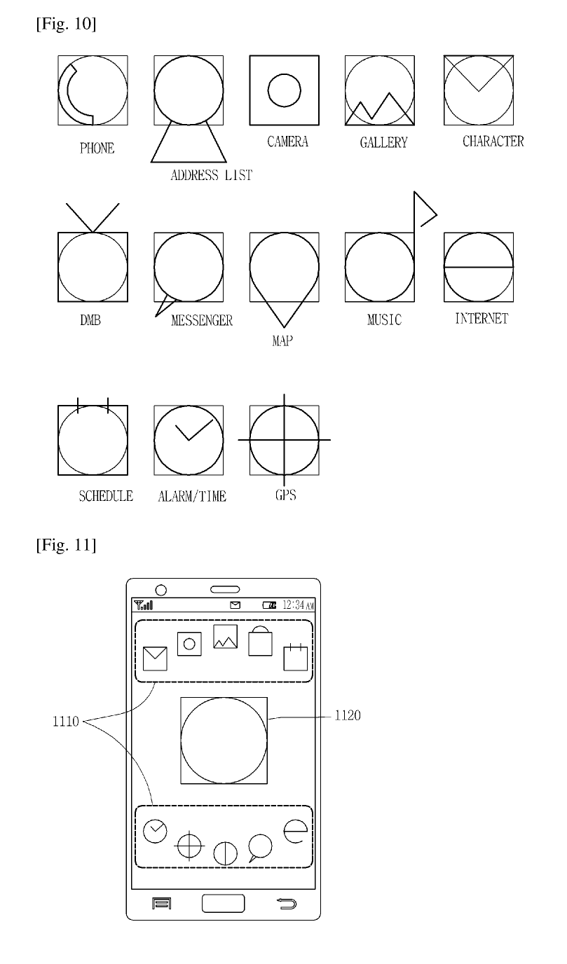

FIG. 10 is a conceptual view illustrating an embodiment of icons corresponding to applications drawn on the basic icon.

In detail, FIG. 10 illustrates an embodiment in which icons corresponding to phone, address list, camera, gallery, text, DMB, messenger, map, music, Internet, schedule, alarm/time, GPS application are drawn on basic icons.

Referring to FIG. 10, the icons corresponding to applications may be drawn within or outside the basic icons, respectively. Also, as described above, although only a portion of a shape of an icon of an application is drawn, the entire icon may be output and an application corresponding to the icon may be executed.

Meanwhile, a list of icons corresponding to a plurality of pre-set applications may be output.

FIG. 11 is a conceptual view illustrating an embodiment of a user interface for outputting a list icons corresponding a plurality of pre-set applications, respectively.

Referring to FIG. 11, lists 1110 of icons corresponding to a plurality of applications, respectively, as described above with reference to FIG. 6 may be output in upper or lower sides of the screen in which a basic icon 1120 is output. Through the lists, the user may easily check an icon corresponding an application desired to be executed.

Meanwhile, when a touch input drawn along a portion or the entirety of a shape of an icon corresponding to a second application is applied, while a first application is being executed, the icon corresponding to the second application may be output and the second application may be executed.

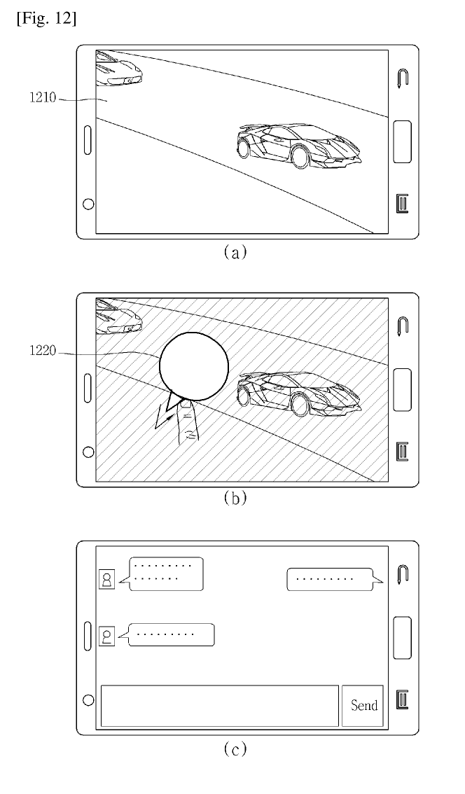

FIG. 12 is a conceptual view illustrating embodiments of a user interface for switching an application being executed.

Referring to (a) and (b) of FIG. 12, the user may apply a touch input of drawing a shape 1120 of an icon corresponding to a messenger application to a screen 1210, while viewing a DMB.

Accordingly, the DMB screen 1210 may be output with a blurred image effect, and the icon 1220 corresponding to the messenger application may be output, while a line is being drawn according to the user's touch input on a higher layer of the DMB screen 1210 output together with the blurred image effect.

Referring to (c) of FIG. 12, after the icon 1220 corresponding to the messenger application is output, the screen may be switched to execute the message application. As a result, the desired application can be simply and quickly executed without the necessity of passing through a home screen.

In another embodiment, as described above, after entering the mode in which basic icons are output by inputting a particular control command, a shape of an icon corresponding to an application may be received.

Meanwhile, when a touch input drawn along a shape of an icon corresponding to a pre-set control command is applied, the icon may be output according to the touch input and the control command may be executed.

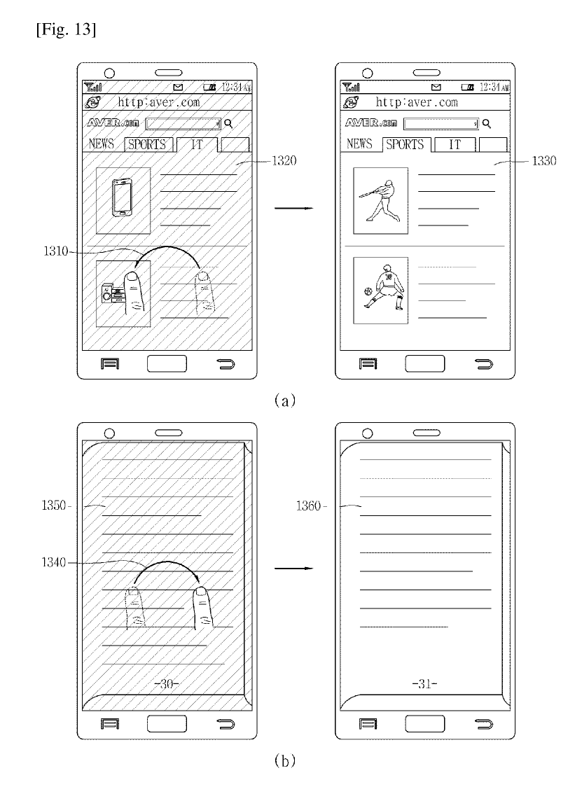

FIG. 13 is a conceptual view illustrating an embodiment of a user interface for executing a pre-set control command according to a touch input drawn along a shape of an icon corresponding to the control command.

Referring to (a) of FIG. 13, when a shape of an arrow icon 1310 pointing to the left of the screen is drawn while an application is being executed, a screen of a previous stage of the application being currently executed is output.

For example, in a case in which the user viewed sports articles 1330 and then clicked an IT article 1320 to view it, when the user draws the shape of the arrow icon 1310, the sports article 1330 is output again. Also, when a touch input is applied to the screen 1320. a blurred image effect may be provided.

Namely, an input of a control command for executing a home button, a menu button, a back button, or the like, may be implemented as a touch input.

Referring to (b) of FIG. 13, while a book application 1350 including a plurality of pages is being executed, when a shape of an arrow icon 1340 pointing to the right is drawn, a next page 1360 is output.

In another example, as described above, after entering the mode in which basic icons are output, a shape of an icon corresponding to a control command may be received.

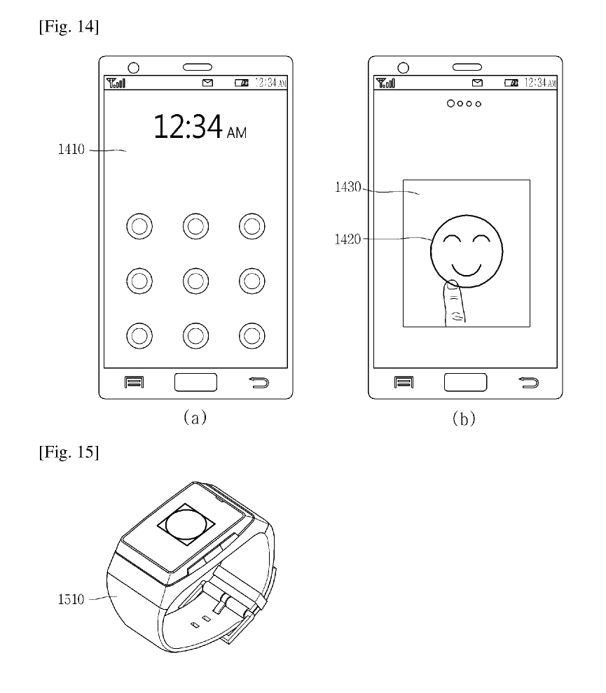

FIG. 14 is a conceptual view illustrating an embodiment of a user interface related to unlocking.

Referring to (a) of FIG. 14, an existing unlocking touch input screen 1410 is displayed, in which an unlocking pattern connecting a portion or the entirety of nine dots may be set.

Referring to (b) of FIG. 14, a shape of an icon 1420 corresponding to an unlocking command may be variously received. Namely, a shape of the icon 1420 corresponding to the unlocking command may be drawn by a touch input to perform unlocking.

In this case, unlocking may be performed in a more complicated and elaborate manner, in comparison to the case of (a) of FIG. 14.

FIG. 15 is a conceptual view illustrating an embodiment of implementing a mobile terminal according to the present invention.

Referring to FIG. 15, the mobile terminal according to an embodiment of the present invention may be implemented as a wearable device. In an embodiment, the mobile terminal according to an embodiment of the present invention may be implemented as a watch-type terminal 1510 as illustrated in FIG. 15. Alternatively, the mobile terminal according to an embodiment of the present invention may also be implemented as a necklace-type terminal.

Since it is difficult to output a plurality of application icons at a time in such a small terminal, the application execution method according to the embodiments of the present invention may be advantageously used.

According to embodiments of the present invention, a desired application may be executed through a simple and intuitive touch input, without having to search an icon corresponding to the application from a home screen.

Also, in a case in which a second application is desired to be executed, while a first application is being executed, inconvenience of the related art method in which the execution of the first application is terminated, a home screen is output again, and an icon corresponding to the second application should be searched can be resolved. Namely, in an embodiment of the present invention, the second application can be executed immediately by applying a touch input, while the first application is being executed.

As a result, user convenience can be enhanced.

In the embodiments of the present invention, the foregoing method may be implemented as codes that can be read by a processor in a program-recorded medium. The processor-readable medium may include a ROM, a RAM, a CD-ROM, a magnetic tape, a floppy disk, an optical data storage device, and the like. The processor-readable medium also includes implementations in the form of carrier waves (e.g., transmission via the Internet).

The mobile terminal according to the embodiments of the present disclosure as described above is not limited in its application of the configurations and methods, but the entirety or a portion of the embodiments can be selectively combined to be configured into various modifications.

As the exemplary embodiments may be implemented in several forms without departing from the characteristics thereof, it should also be understood that the above-described embodiments are not limited by any of the details of the foregoing description, unless otherwise specified, but rather should be construed broadly within its scope as defined in the appended claims. Therefore, various changes and modifications that fall within the scope of the claims, or equivalents of such scope are therefore intended to be embraced by the appended claims.

1. A mobile terminal comprising:
a display unit configured to receive a touch input drawn along a portion or the entirety of a shape of an icon corresponding to a pre-set application and output the icon according to the touch input; and
a controller configured to execute the application corresponding to the icon drawn along the touch input.

2. The mobile terminal of claim 1, wherein when the touch input drawn along a portion or the entirety of the shape of the icon corresponding to the pre-set application on a pre-set basic icon is applied, the controller outputs the icon according to the touch input and execute the application corresponding to the icon.

3. The mobile terminal of claim 1, wherein the controller outputs a list of icons corresponding to a plurality of pre-set applications, respectively.

4. The mobile terminal of claim 1, wherein when a touch input drawn along a portion or the entirety of an icon corresponding to a second application is applied while a first application is being executed, the controller outputs an icon corresponding to the second application and execute the second application according to the touch input.

5. The mobile terminal of claim 1, wherein when a touch input drawn along a shape of an icon corresponding to a pre-set control command is applied, the controller outputs the icon and execute the control command according to the touch input.

6. A control method of a mobile terminal, the method comprising:
(a) receiving a touch input drawn along a portion or the entirety of a shape of an icon corresponding to a pre-set application; and
(b) outputting the icon drawn along the touch input and executing the application corresponding to the icon.

7. The control method of claim 6, wherein
the operation (a) comprises:
receiving a touch input drawn along a portion or the entirety of the shape of the icon corresponding to the pre-set application on a pre-set basic icon, and
the operation (b) comprises:
outputting the icon according to the touch input and executing the application corresponding to the icon.

8. The control method of claim 6, wherein
the operation (a) comprises:
outputting a list of icons corresponding to a plurality of pre-set applications, respectively.

9. The control method of claim 6, wherein
the operation (a) comprises:
receiving a touch input drawn along a portion or the entirety of an icon corresponding to a second application while a first application is being executed; and
the operation (b) comprises:
outputting an icon corresponding to the second application and executing the second application according to the touch input.

10. The control method of claim 6, wherein
the operation (a) comprises:
receiving a touch input drawn along a shape of an icon corresponding to a pre-set control command, and
the operation (b) comprises:
outputting the icon and executing the control command according to the touch input.
